(19) United States
(12) Patent Application Publication
(10) Pub. No.: US 2008/0204939 A1
(43) Pub. Date: Aug. 28, 2008

(54) MAGNETIC DISK DEVICE

(75) Inventor: Hitoshi Komoriya, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/026,283

(22) Filed: Feb. 5, 2008

(30) Foreign Application Priority Data
Feb. 28, 2007 (JP) 2007-48867

(51) Int. Cl. G11B 5/54

(52) U.S. Cl. 360/254

(57) ABSTRACT

A magnetic disk device performs yaw angle correction of a magnetic head is compact, and performs yaw angle correction without changing the arm length. A suspension is rotatably provided on the tip of an arm which is rotated by a rotating actuator and an interconnection device is provided, one end of which is connected to a fixed shaft fixed on a housing, the other end of which is connected to a rotating shaft of the suspension, and which, by means of rotation of the arm, causes rotation of the suspension about the rotating shaft in the direction opposite the direction of rotation of the arm.

### CROSS-REFERENCE TO RELATED APPLICATIONS

This application is based upon and claims the benefit of priority from the prior Japanese Patent Application No. 2007-48867, filed on Feb. 28, 2007, the entire contents of which are incorporated herein by reference.

### BACKGROUND OF THE INVENTION

1. Field of the Invention

The present invention relates to a magnetic disk device, in which a head is moved in the radial direction of a rotating magnetic disk and is positioned at a desired track, and the head is used for reading and writing of data on the track, and in particular relates to a magnetic disk device having a head inclination correction mechanism of the head inclined in a tangential direction for the disk.

2. Description of the Related Art

Disk devices in which storage media comprises a rotating member are widely used as storage devices connected to host computers. In disk devices, a head is positioned at a track of a disk, and the head reads and writes data from and to the track. For this reason, the position of the head on the disk must be detected.

FIG. 10 explains a magnetic disk device of the prior art. A magnetic disk 102 is mounted on the rotating shaft 104 of a spindle motor. Through rotation by the spindle motor, the magnetic disk 102 rotates. On the other hand, a magnetic head 112 (read element and write element) is provided at the tip of an arm 108, and is driven in rotation about a rotation shaft 110 by means of a VCM (Voice Coil Motor) 106, which is a fixed rotation-type actuator.

A ramp loading mechanism 114 is provided which retracts the magnetic head 112 from the magnetic disk 102 as necessary and parks the head. These mechanisms are accommodated within the device housing 100.

In this magnetic disk device, the arm 108 rotates the magnetic head 102 in the radial direction by means of the VCM 106, and positions the magnetic head 112 at a desired track of the magnetic disk 102. Tracks are formed concentrically on the magnetic disk 102, and by means of rotation of the magnetic disk 102, the magnetic head 112 reads and writes the data of one track.

In such a magnetic disk device, the distance between the centers of the rotation shaft 110 of the arm 108 and the rotation shaft 104 of the magnetic disk 102 is made short, and the VCM 106 is brought as close as possible to the magnetic disk 102 to reduce the device size. For this reason, the head arm length is also limited, and the moving path of the magnetic head 112 over the magnetic disk 102 is an arc shape.

For this reason, the inclination (called the yaw angle) of the magnetic head 112 relative to the tangential direction of the magnetic disk 102 differs at each track position of the magnetic disk 102. That is, there exist tracks for which the yaw angle is large, and tracks for which the yaw angle is small. The longer the arm length, the smaller is the difference in yaw angle with track position; but as explained above, when the arm length is limited, the difference in yaw angle at different track positions cannot be made small.

This inclination in the magnetic head relative to the track affects the track write performance in particular. Especially in magnetic disk devices using perpendicular recording, the write element 112-1 of the magnetic head 112 writes a magnetic pattern into the magnetic disk 102 which is close to the shape of the write element surface opposed to the disk media 102.

For this reason, as shown in FIG. 11, when the shape of the write element 112-1 is a rectangular (strip) shape, at tracks 102-2 for which the head inclination (yaw angle) relative to the media tangential direction is small, the write element 112-1 can write a perpendicular magnetic recording pattern within the track width (track pitch). However, at tracks 102-1 for which the head inclination (yaw angle) relative to the media tangential direction is large, the leading side of the head 112 protrudes from the track in the radial direction of the media 102, the track pitch is increased, and there is the problem that high densities cannot be achieved.

Hence in perpendicular magnetic recording magnetic disk devices of the prior art, a taper is added to the leading side of the write element 112-2 (a corner of the element is cut at a certain angle), as shown in FIG. 12, to suppress protrusion in the radial direction of the leading side of the head in tracks 102-1 where the yaw angle is large. By this means, increases in track pitch are suppressed, and the required recording density is achieved.

However, if the track pitch is reduced in order to further raise the recording density, the core width of the write element 112-2 becomes narrower substantially in proportion to the track pitch, and the magnetic field generated from the write element 112-2 is reduced. As a result, as shown in FIG. 12, if a taper is added to the leading side of the write element 112-2, it may not be possible to generate the magnetic field necessary for recording to the medial 102.

In order to suppress such changes in yaw angle, various yaw correction mechanisms have been proposed in the prior art. A first technology of the prior art is a method of extending the head arm length beyond the normal length, and setting a small range of yaw angle change (see for example Japanese Patent Laid-open No. 5-298615).

A second technology of the prior art is a method in which a MEMS (micro-machine) or other driving mechanism is incorporated midway in the arm, and by means of coordinated control of the MEMS rotation angle simultaneously with the rotation angle of the rotation actuator of the arm, suppressing changes in yaw angle (see for example Japanese Patent Laid-open No. 2001-101633).

A third technology of the prior art proposes the configuration shown in FIG. 13 (see for example Japanese Patent Laid-open No. 63-288458). That is, one end of the head arm 118 is provided on a fixed rotating shaft 116, and an arm 122 comprising the head 112 on the tip is provided on the tip portion of the head arm 118; a steel belt 124 wound about the rotating shaft of a motor 120 is provided at the tip portion of the head arm 118. The arm 122 is provided at an inclination to the head arm 118, so that the head arm tip is rotated by rotation of the motor 120, and the head 112 at the tip of the arm 122 moves in the radial direction of the magnetic disk 102. Here, 114 is a ramp loading mechanism, and 100 is a housing.

However, in the first technology of the prior art the arm length is extended, and so the arm cannot be kept within the dimensions stipulated by the form factor of the magnetic disk device. Further, there is the problem that arm lengthening results in reduced arm rigidity and decreased stability with respect to shocks.

In the second technology of the prior art, a micro-actuator (micro-machine) is added, so that reduced arm rigidity and lowering of the first-order resonance point occur, and as a result the servo bandwidth is reduced. Further, because the driving force of the micro-actuator is small, reduced rotation velocity and acceleration tend to occur, and high-speed seeking becomes difficult. Also, there is the manufacturing-related problem that integration of the MEMS formation processes with head formation processes is difficult.

In the third technology of the prior art, the head arm length is increased, so that problems similar to those of the first technology of the prior art arise; in addition, if a motor is incorporated within the disk device, the dimensions stipulated by the form factor of the disk device cannot be maintained, and there is the problem that the device size is increased.

Hence an object of the invention is to provide a magnetic disk device which can be accommodated within the dimensions stipulated by the device form factor, and which can realize yaw angle correction without a decline in arm rigidity.

A further object of the invention is to provide a magnetic disk device which can be accommodated within the dimensions stipulated by the device form factor, and which performs yaw angle correction while maintaining fast seek performance.

A further object of the invention is to provide a magnetic disk device which performs yaw angle correction without using a micro-actuator.

A further object of the invention is to provide a magnetic disk device which performs yaw angle correction optimally for high-density perpendicular magnetic recording.

### SUMMARY OF THE INVENTION

In order to attain these objects, a magnetic disk device of this invention is provided with a magnetic disk; a spindle motor which rotates the magnetic disk; a rotating actuator which rotates an arm; a suspension, rotatably provided at the tip of the arm; a magnetic head, provided at the tip of the suspension; and a interconnection mechanism, one end of which is connected to a fixed shaft fixed to the housing, the other end of which is linked to a rotating shaft of the suspension, and which, through rotation of the arm, causes the suspension to rotate about the rotating shaft in the direction opposite the rotation direction of the arm.

In this invention, it is preferable that the interconnection mechanism have a link mechanism, one end of which is provided rotatably on the fixed shaft, and the other end of which is mounted on the rotating shaft.

In this invention, it is preferable that the link mechanism have a first link member, one end of which is rotatably provided on the fixed shaft, and a second link member, one end of which is mounted via a joint on the other end of the first link member, and the other end of which is mounted on the rotating shaft.

In this invention, it is preferable that the fixed shaft be provided at a position different from the rotating shaft of the rotating actuator.

In this invention, it is preferable that the interconnection mechanism have a gear mechanism which, by means of rotation of the arm, causes the suspension to rotate about the rotating shaft in the direction opposite the rotation direction of the arm.

In this invention, it is preferable that the gear mechanism have a third gear, fixed on the fixed shaft; a second gear, rotatably provided on the arm, and which meshes with the third gear; and a first gear, mounted on the rotating shaft, and which meshes with the second gear.

In this invention, it is preferable that the fixed shaft be provided at the same center position as the rotating shaft of the rotating actuator.

In this invention, it is preferable that the interconnection mechanism have a belt mechanism, which, by means of rotation of the arm, causes the suspension to rotate about the rotating shaft in the direction opposite the rotation direction of the arm.

In this invention, it is preferable that the belt mechanism have a second pulley, fixed to the fixed shaft; a first pulley, mounted on the rotating shaft; and a belt, which is stretched over the first and second pulleys.

In this invention, it is preferable that the belt have a steel belt.

In this invention, it is preferable that the fixed shaft be provided at the same center position as the rotating shaft of the rotating actuator.

In this invention, it is preferable that the magnetic disk has a perpendicular magnetic recording medium, and that the magnetic head has a perpendicular magnetic recording element.

In this invention, it is preferable that the perpendicular magnetic recording element have an element which forms a rectangular magnetic pattern in the perpendicular magnetic recording medium.

Since a rotatably suspension on the tip of an arm rotated by a rotating actuator, and an interconnection mechanism one end of which is connected to a fixed shaft fixed in the housing, the other end of which is connected to a rotating shaft of the suspension, and which, by means of rotation of the arm, rotates the suspension about the rotating shaft in the direction opposite the direction of arm rotation are provided, a yaw angle correction mechanism can be realized within the disk device form factor, and moreover there is no need to extend the arm length and no need to provide a micro-actuator, so that reduction of rigidity can be prevented, and a configuration which is resistant to vibrations can be realized.

### BRIEF DESCRIPTION OF THE DRAWINGS

FIG. 1 is a front view of a first embodiment of a magnetic disk device of the invention;

FIG. 2 explains the yaw angle correction operation of the configuration of FIG. 1;

FIG. 3 is a cross-sectional view of the configuration of FIG. 1;

FIG. 4 is a front view of a second embodiment of a magnetic disk device of the invention;

FIG. 5 explains the yaw angle correction operation of the configuration of FIG. 4;

FIG. 6 is a cross-sectional view of the configuration of FIG. 4;

FIG. 7 is a front view of a third embodiment of a magnetic disk device of the invention;

FIG. 8 explains the yaw angle correction operation of the configuration of FIG. 7;

FIG. 9 is a cross-sectional view of the configuration of FIG. 7;

FIG. 10 shows the configuration of a magnetic disk device of the prior art;

FIG. 11 explains a perpendicular magnetic recording method of the prior art;

FIG. 12 explains another perpendicular magnetic recording method of the prior art; and

FIG. 13 explains a yaw angle correction mechanism of the prior art.

### DESCRIPTION OF THE PREFERRED EMBODIMENTS

Below, embodiments of the invention are explained, in the order of a first embodiment of a magnetic disk device, a second embodiment of a magnetic disk device, a third embodiment of a magnetic disk device, and other embodiments; however, the invention is not limited to these embodiments.

### First Embodiment of a Magnetic Disk Device

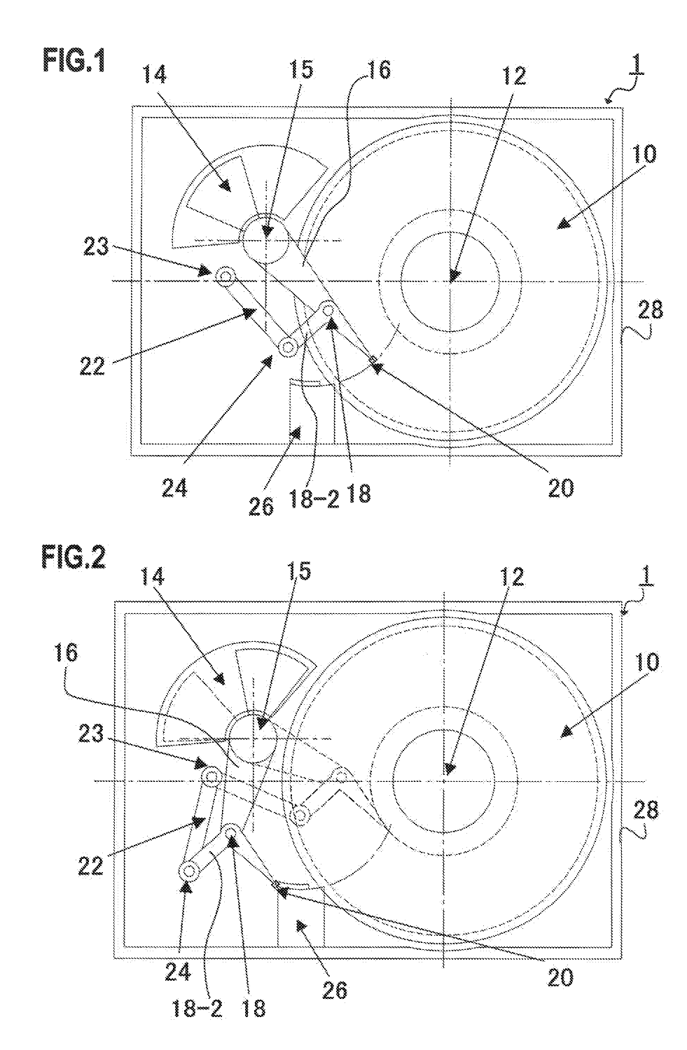

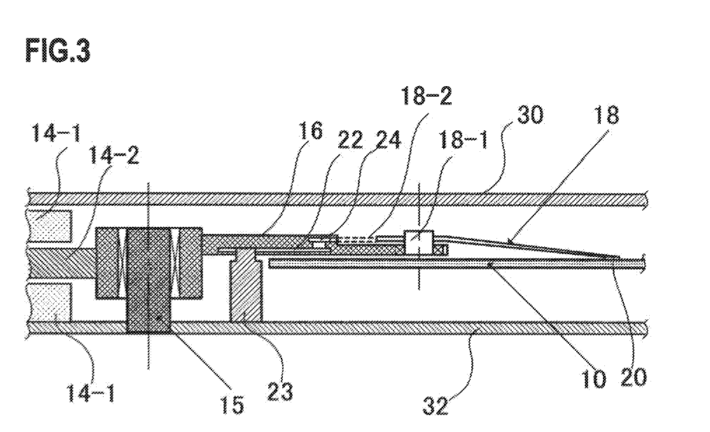

FIG. 1 is a front view of a first embodiment of a magnetic disk device of the invention, FIG. 2 explains yaw angle correction operation of the configuration of FIG. 1, and FIG. 3 is a cross-sectional view of the magnetic disk device of FIG. 1.

As shown in FIG. 1, the magnetic disk 10 which is perpendicular magnetic recording media is mounted on the rotating shaft 12 of a spindle motor. The spindle motor rotates the rotating shaft 12, to rotate the magnetic disk 10. The arm 16 is rotated about the rotating shaft 15 by a VCM (Voice Coil Motor) 14. A suspension 18 is rotatably mounted on the tip of this arm 16.

On the tip of the suspension 18 is provided the magnetic head 20 (read element and write element). Further, a ramp loading mechanism 26, which retracts the magnetic head 20 from the magnetic disk 10 and parks the head, is provided. These mechanisms are accommodated in a device housing 28.

In this magnetic disk device, tracks are formed concentrically on the magnetic disk 10, and the arm 16 is rotated in the radial direction of the magnetic disk 10 by the VCM 14 to position the magnetic head 20 at a desired track on the magnetic disk 10. The magnetic head 20 performs data reading and writing in one track by means of rotation of the magnetic disk 10.

The magnetic head 20 has a read element and a write (perpendicular recording) element. The magnetic head 20 comprises a read element comprising a magneto-resistive (MR) element stacked on a slider, and a write element comprising a write coil stacked thereupon.

Details are explained referring to FIG. 3. The rotating shaft 15 of the arm 16 is mounted on the housing base 32. The arm 16 is rotatably mounted on this rotating shaft 15 via a bearing. The VCM 14 comprises a VCM fixed portion 14-1 mounted on the device housing, and a VCM rotating portion 14-2 mounted on the arm 16. The VCM fixed portion 14-1 comprises a permanent magnet, and the VCM rotating portion 14-2 comprises a coil.

On the tip of the arm 16 is provided a rotating shaft (joint) 18-1, and the suspension 18 is mounted on the rotating shaft. As shown in FIG. 1, a first link member 18-2 is provided, either interconnected with or integrally with the suspension 18.

A fixed shaft 23 is provided on the housing base 32. One end of a second link member 22 is rotatably provided on this fixed shaft 23. The other end of this second link member 22 is rotatably connected to one end of the first link member 18-2 by a joint (rotating shaft) 24.

That is, midway on the arm, the link mechanism 23, 22, 24, 18-2, 18-1 is provided. As shown in FIG. 1 and FIG. 2, when by means of the VCM 14 the arm 16 is rotated about the rotating shaft 15, the rotating force of the arm 16 causes the link members 22 and 18-2 to operate, and the suspension 18 is rotated in the direction opposite the direction of rotation of the arm 16.

By means of rotation of the arm 16, the moving path of the tip of the suspension 18 (that is, the magnetic head 20) is an arc, and a yaw angle occurs, but because of the link mechanism, the suspension 18 rotates in the direction opposite the direction of rotation of the arm 16. This opposite-direction rotation is opposite the direction of occurrence of the above-described yaw angle, so that the yaw angle is cancelled.

That is, because there is a 1:1 relation between the rotation angle of the rotating actuator (VCM) 14 which rotates the arm 16 and the rotation angle midway on the arm 16, the suspension 18 rotates midway on the arm 16 through the angle opposite this rotation angle. By this means, the occurrence of a yaw angle due to rotation of the arm 16 is suppressed.

Hence the rotation angle of the rotating actuator 14 of the arm 16 is transmitted by means of the transmission mechanism, to realize rotation for yaw angle correction. That is, an interconnection member is provided, one end of which is connected to the fixed shaft 23 fixed to the housing, and the other end of which is connected to the rotating shaft 18-1 of the suspension 18, and by means of rotation of the arm 16, the interconnection mechanism causes the suspension 18 to rotate in the direction opposite the direction of rotation of the arm 16.

As a result, yaw angle correction can be realized without extending the arm length, and without providing a micro-actuator. By this means yaw angle correction can be achieved within the dimensions of the form factor of the magnetic disk device, and moreover rigidity is maintained, and operation not affected by external vibrations or by vibrations due to high-speed seeking can be realized.

In this embodiment, by installing a link mechanism midway on the arm 16, the head direction is held constant regardless of the arm rotation angle. By this means, yaw angle change can be suppressed to within 0° to 6.3°. Further, the link mechanism has the further advantages of a simple configuration and low cost.

### Second Embodiment of a Magnetic Disk Device

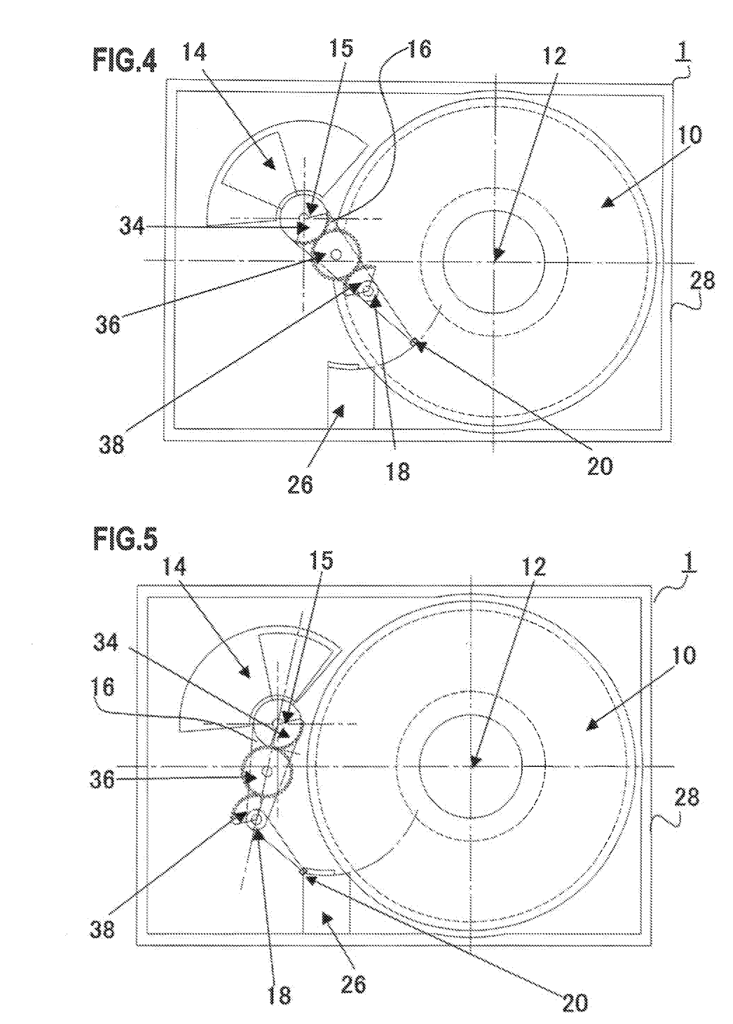

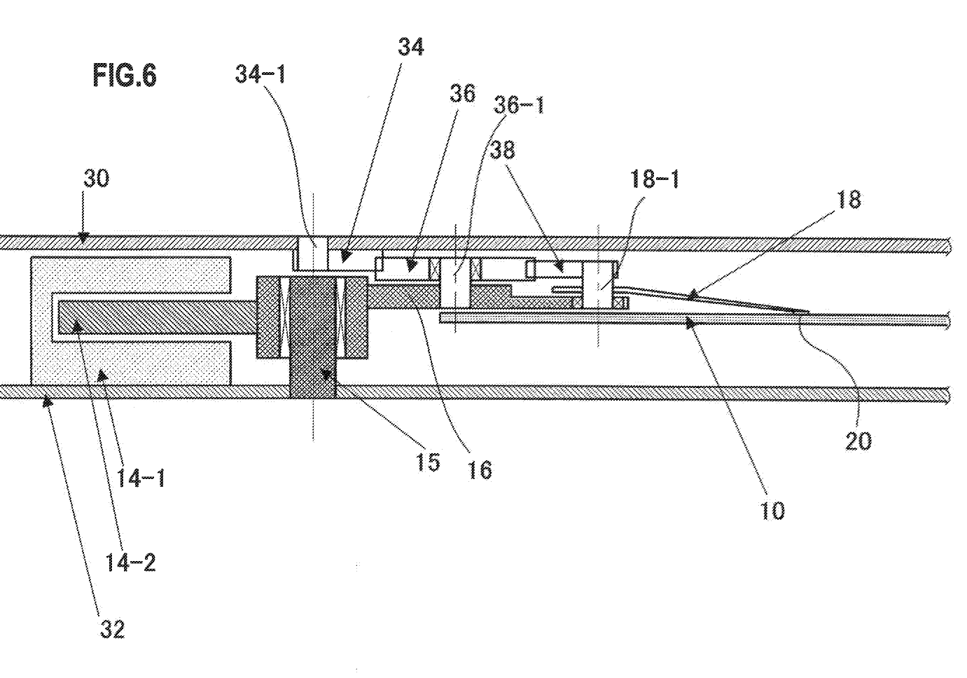

FIG. 4 is a front view of a second embodiment of a magnetic disk device of the invention, FIG. 5 explains yaw angle correction operation of the configuration of FIG. 4, and FIG. 6 is a cross-sectional view of the magnetic disk device of FIG. 4.

As shown in FIG. 4, similarly to FIG. 1, a magnetic disk 10 which is perpendicular magnetic recording media is provided on the rotating shaft 12 of a spindle motor. The spindle motor rotates the rotating shaft 12 to rotate the magnetic disk 10. The arm 16 is rotated about the rotating shaft 15 by a VCM (Voice Coil Motor) 14. On the tip of this arm 16 is rotatably mounted a suspension 18.

On the tip of the suspension 18 is provided a magnetic head 20 (read element and write element). Further, a ramp loading mechanism 26 is provided which retracts the magnetic head 20 from the magnetic disk 10 and parks the head. These mechanisms are accommodated within a device housing 28.

In this magnetic disk device, tracks are formed concentrically on the magnetic disk 10, and the arm 16 is rotated in the radial direction of the magnetic disk 10 by the VCM 14 to position the magnetic head 20 at a desired track on the magnetic disk 10. The magnetic head 20 performs data reading and writing in one track by means of rotation of the magnetic disk 10.

The magnetic head 20 comprises a read element and a write (perpendicular recording) element. The magnetic head 20 comprises a read element comprising a magneto-resistive (MR) element stacked on a slider, and a write element comprising a write coil stacked thereupon.

Details are explained referring to FIG. 6. The rotating shaft 15 of the arm 16 is mounted on the housing base 32. The arm 16 is rotatably mounted on this rotating shaft 15 via a bearing. The VCM 14 comprises a VCM fixed portion 14-1 mounted on the device housing, and a VCM rotating portion 14-2 mounted on the arm 16. The VCM fixed portion 14-1 comprises a permanent magnet, and the VCM rotating portion 14-2 comprises a coil.

On the tip of the arm 16 is provided a rotating shaft (joint) 18-1; the suspension 18 is mounted on the rotating shaft. As shown in FIG. 4, a first gear 38 is provided on the rotating shaft 18-1 of the suspension 18. Also, a rotating shaft 36-1 is provided on the arm 16, and a second gear 36 is provided on this rotating shaft 36-1 so as to mesh with the first gear 38.

On the housing base (upper side) 30 is provided a fixed shaft 34-1. A third gear 34 is fixed on this fixed shaft 34-1 so as to mesh with the second gear 36. That is, a gear mechanism 34, 36, 38 is provided midway on the arm.

As shown in FIG. 4 and FIG. 5, when the arm 16 is rotated about the rotating shaft 15 by the VCM 14, the second gear 36 provided on the arm 16 and meshing with the fixed third gear 34 is rotated in the same direction as the rotation direction of the VCM 14 due to the rotating force of the arm 16, and causes the first gear 38 to rotate in the direction opposite the direction of rotation of the VCM 14.

By means of rotation of the arm 16, the path of the tip of the suspension 18 (that is, the magnetic head 20) is an arc, and a yaw angle occurs, but because of the gear mechanism, the suspension 18 rotates in the direction opposite the direction of rotation of the arm 16. This opposite-direction rotation is opposite the direction of occurrence of the above-described yaw angle, so that the yaw angle is cancelled.

Similarly to FIG. 1 through FIG. 3, because there is a 1:1 relation between the rotation angle of the rotating actuator (VCM) 14 which rotates the arm 16 and the rotation angle midway on the arm 16, the suspension 18 rotates midway on the arm 16 through the angle opposite this rotation angle. By this means, the occurrence of a yaw angle due to rotation of the arm 16 is suppressed.

Hence the rotation angle of the rotating actuator 14 of the arm 16 is transmitted by means of the transmission mechanism, to realize rotation for yaw angle correction. That is, an interconnection member is provided, one end of which is connected to the fixed shaft 23 fixed to the housing, and the other end of which is connected to the rotating shaft 18-1 of the suspension 18, and by means of rotation of the arm 16, the interconnection mechanism causes the suspension 18 to rotate in the direction opposite the direction of rotation of the arm 16.

As a result, yaw angle correction can be realized without extending the arm length, and without providing a micro-actuator. By this means yaw angle correction can be achieved within the dimensions of the form factor of the magnetic disk device, and moreover rigidity is maintained, and operation not affected by external vibrations or by vibrations due to high-speed seeking can be realized.

In this embodiment, by installing a gear mechanism midway on the arm 16, the head direction is held constant regardless of the arm rotation angle. By this means, yaw angle change can be suppressed to within 0° to 6.3°. Further, the gear mechanism has the further advantages of being able to be accommodated within the arm, and not requiring additional space.

### Third Embodiment of a Magnetic Disk Device

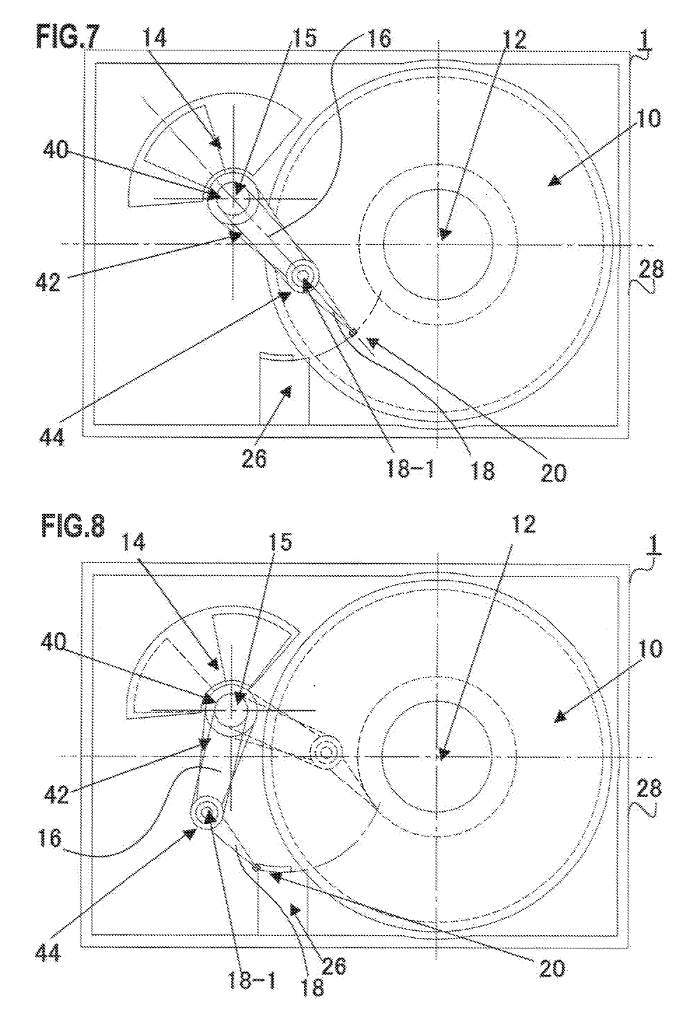

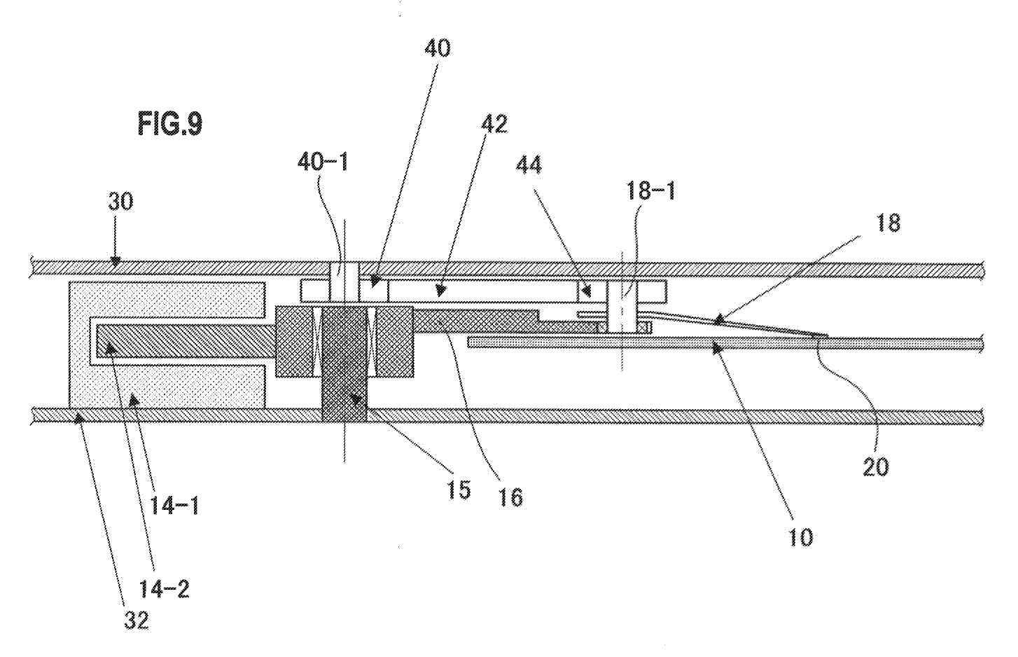

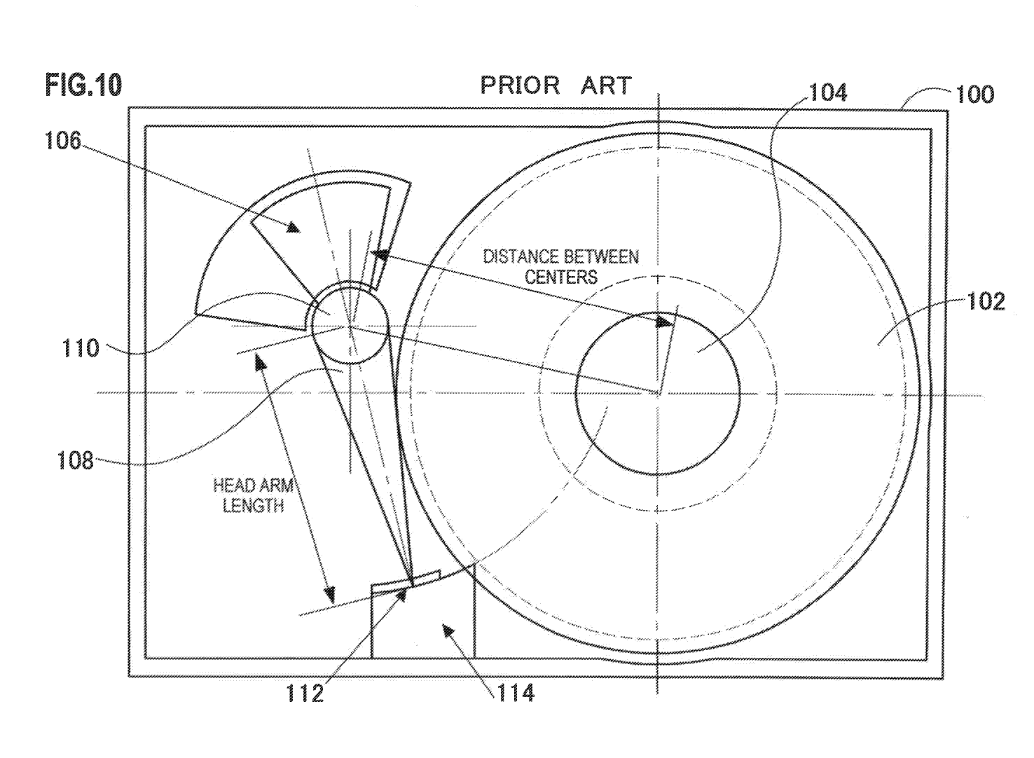

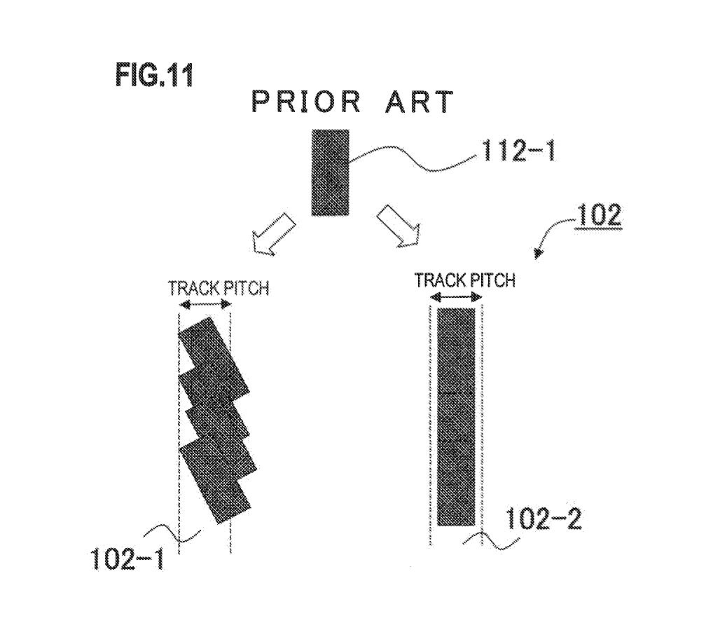

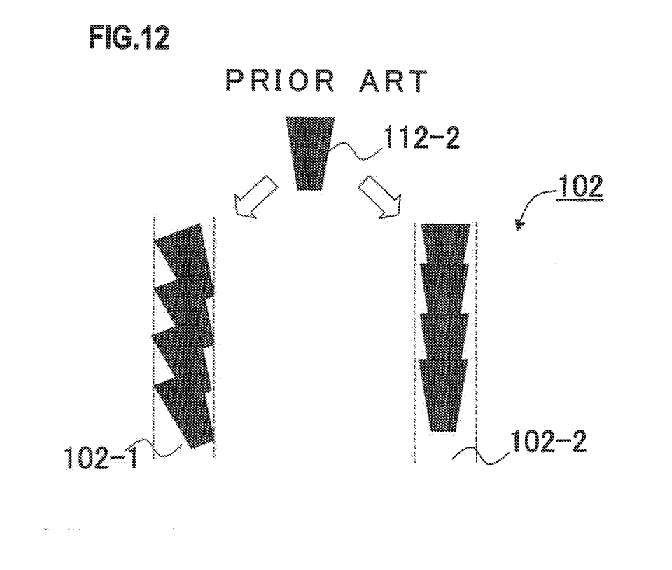

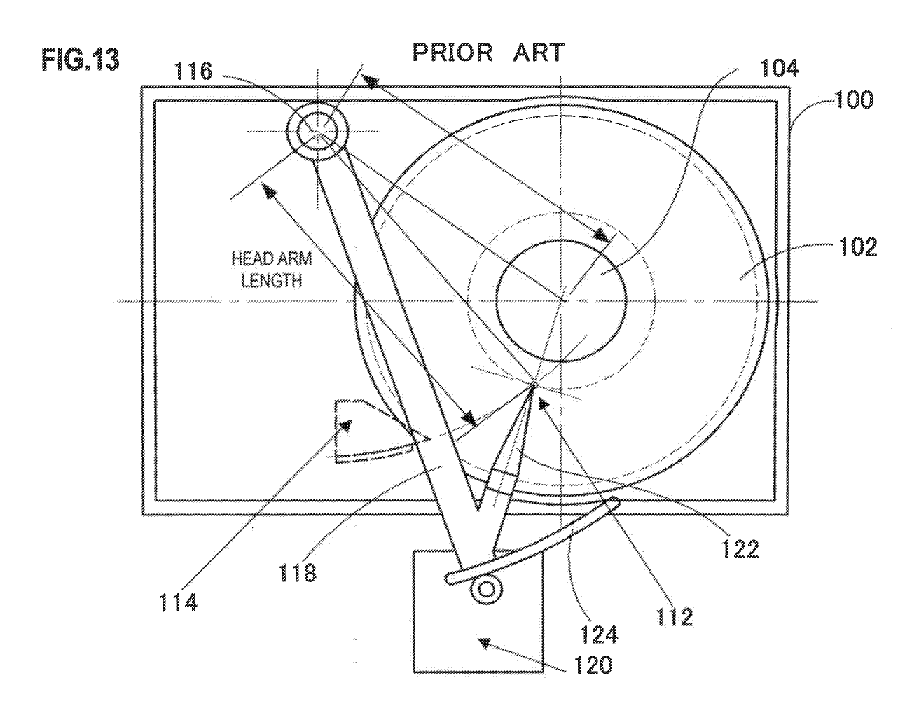

FIG. 7 is a front view of a third embodiment of a magnetic disk device of the invention, FIG. 8 explains yaw angle correction operation of the configuration of FIG. 7, and FIG. 9 is a cross-sectional view of the magnetic disk device of FIG. 7.

As shown in FIG. 7, similarly to FIG. 1 through FIG. 6, a magnetic disk 10 which is perpendicular magnetic recording media is provided on the rotating shaft 12 of a spindle motor. The spindle motor rotates the rotating shaft 12 to rotate the magnetic disk 10. The arm 16 is rotated about the rotating shaft 15 by a VCM (Voice Coil Motor) 14. On the tip of this arm 18 is rotatably mounted a suspension 18.

On the tip of the suspension 18 is provided a magnetic head 20 (read element and write element). Further, a ramp loading mechanism 26 is provided which retracts the magnetic head 20 from the magnetic disk 10 and parks the head. These mechanisms are accommodated within a device housing 28.

In this magnetic disk device, tracks are formed concentrically on the magnetic disk 10, and the arm 16 is rotated in the radial direction of the magnetic disk 10 by the VCM 14 to position the magnetic head 20 at a desired track on the magnetic disk 10; the magnetic head 20 performs data reading and writing in one track by means of rotation of the magnetic disk 10.

The magnetic head 20 comprises a read element and a write (perpendicular recording) element. The magnetic head 20 comprises a read element comprising a magneto-resistive (MR) element stacked on a slider, and a write element comprising a write coil stacked thereupon.

Details are explained referring to FIG. 9. The rotating shaft 15 of the arm 16 is mounted on the housing base 32. The arm 16 is rotatably mounted on this rotating shaft 15 via a bearing. The VCM 14 comprises a VCM fixed portion 14-1 mounted on the device housing, and a VCM rotating portion 14-2 mounted on the arm 16. The VCM fixed portion 14-1 comprises a permanent magnet, and the VCM rotating portion 14-2 comprises a coil.

On the tip of the arm 16 is provided a rotating shaft (joint) 18-1; the suspension 18 is mounted on the rotating shaft. As shown in FIG. 7, a first pulley 44 is fixed to the rotating shaft 18-1.

On the housing base 30 is provided a fixed shaft 40-1. A second pulley 40 is rotatably provided on this fixed shaft 40-1. A rigid belt (for example, a steel belt) 42 is passed over these first and second pulleys 40 and 44.

That is, a belt mechanism 40, 42 and 44 is provided midway on the arm. As shown in FIG. 7 and FIG. 8, when the arm 16 is rotated about the rotating shaft 15 by the VCM 14, the second pulley 44 is fixed, and so the belt 42 does not move. Hence by means of the rotating force of the VCM 14 and arm 16, the first pulley 40 causes the rotating shaft 18-1 to rotate in the direction opposite the direction of rotation of the arm 16. As a result, the suspension 18 fixed to the rotating shaft 18-1 also rotates in the direction opposite the rotation direction of the arm 16.

By means of rotation of the arm 16, the path of the tip of the suspension 18 (that is, the magnetic head 20) is an arc, and a yaw angle occurs, but because of the belt mechanism, the suspension 18 rotates in the direction opposite the direction of rotation of the arm 16. This opposite-direction rotation is opposite the direction of occurrence of the above-described yaw angle, so that the yaw angle is cancelled.

That is, because there is a 1:1 relation between the rotation angle of the rotating actuator (VCM) 14 which rotates the arm 16 and the rotation angle midway on the arm 16, the suspension 18 rotates midway on the arm 16 through the angle opposite this rotation angle. By this means, the occurrence of a yaw angle due to rotation of the arm 16 is suppressed.

Hence the rotation angle of the rotating actuator 14 of the arm 16 is transmitted by means of the transmission mechanism, to realize rotation for yaw angle correction. That is, an interconnection member is provided, one end of which is connected to the fixed shaft 40-1 fixed to the housing, and the other end of which is connected to the rotating shaft 18-1 of the suspension 18, and by means of rotation of the arm 16, the interconnection mechanism causes the suspension 18 to rotate in the direction opposite the direction of rotation of the arm 16.

As a result, yaw angle correction can be realized without extending the arm length, and without providing a micro-actuator. By this means yaw angle correction can be achieved within the dimensions of the form factor of the magnetic disk device, and moreover rigidity is maintained, and operation not affected by external vibrations or by vibrations due to high-speed seeking can be realized.

In this embodiment, by installing a belt mechanism midway on the arm 16, the head direction is held constant regardless of the arm rotation angle. By this means, yaw angle change can be suppressed to within 0° to 6.3°. Further, the belt mechanism has the further advantages of having a simple configuration, being inexpensive, and being able to be accommodated within the arm.

### Other Embodiments

In the above-described embodiments, examples were explained in which the magnetic disk device is a perpendicular magnetic disk device; but application to optically-assisted perpendicular magnetic disk devices and to other disk devices is also possible. Also, as explained above, when magnetic heads 20 and suspensions 18 are provided on both faces of a magnetic disk 10, the same yaw angle correction mechanism can be provided for each suspension.

In the above, embodiments of the invention have been explained; but various modifications of the invention are possible within the gist thereof, and these modifications are not excluded from the scope of the invention.

A suspension is rotatably provided on the tip of an arm rotated by a rotating actuator, and an interconnection mechanism is provided, one end of which is connected to a fixed shaft fixed to the housing, the other end of which is connected to the rotating shaft of the suspension, and which, by means of the arm rotation, rotates the suspension about the rotating shaft in the direction opposite the rotation direction of the arm; hence a yaw angle correction mechanism can be realized within the disk device form factor, and because the arm length need not be extended and no micro-actuator need be provided, reductions in rigidity can be prevented, and a configuration not easily affected by vibrations can be realized.

What is claimed is:

1. A magnetic disk device, comprising:
a magnetic disk;
a spindle motor, which rotates the magnetic disk;
a rotating actuator, which rotates an arm;
a suspension, rotatably provided at a tip of the arm;
a magnetic head, provided at a tip of the suspension; and
a interconnection mechanism, one end of which is connected to a fixed shaft fixed to a housing, the other end of which is linked to a rotating shaft of the suspension, and which, through rotation of the arm, causes the suspension to rotate about the rotating shaft in a direction opposite a rotation direction of the arm.

2. The magnetic disk device according to claim 1, wherein the interconnection mechanism comprises a link mechanism, one end of which is rotatably provided on the fixed shaft, and the other end of which is mounted on the rotating shaft.

3. The magnetic disk device according to claim 2, wherein the link mechanism comprises:
a first link member, one end of which is rotatably provided on the fixed shaft; and
a second link member, one end of which is mounted via a joint on the other end of the first link member, and the other end of which is mounted on the rotating shaft.

4. The magnetic disk device according to claim 2, wherein the rotating shaft is provided at a position different from the rotating shaft of the rotating actuator.

5. The magnetic disk device according to claim 1, wherein the interconnection mechanism comprises a gear mechanism, which, by means of the rotation of the arm, rotates the suspension about the rotating shaft in the direction opposite the rotation direction of the arm.

6. The magnetic disk device according to claim 5, wherein the gear mechanism comprises:
a third gear fixed on the fixed shaft;
a second gear rotatably provided on the arm and meshing with the third gear; and
a first gear mounted on the rotating shaft and meshing with the second gear.

7. The magnetic disk device according to claim 6, wherein the fixed shaft is provided in the same center position as the rotating shaft of the rotating actuator.

8. The magnetic disk device according to claim 1, wherein the interconnection mechanism comprises a belt mechanism which, by means of the rotation of the arm, rotates the suspension about the rotating shaft in the direction opposite the rotation direction of the arm.

9. The magnetic disk device according to claim 8, wherein the belt mechanism comprises:
a second pulley fixed to the fixed shaft;
a first pulley mounted on the rotating shaft; and
a belt stretched over the first and second pulleys.

10. The magnetic disk device according to claim 9, wherein the belt comprises a steel belt.

11. The magnetic disk device according to claim 9, wherein the fixed shaft is provided in the same center position as the rotating shaft of the rotating actuator.

12. The magnetic disk device according to claim 1, wherein the magnetic disk comprises a perpendicular magnetic recording medium, and the magnetic head comprises a perpendicular magnetic recording element.

13. The magnetic disk device according to claim 12, wherein the perpendicular magnetic recording element comprises an element which forms a rectangular magnetic pattern in the perpendicular magnetic recording medium.
